(19) United States
(12) Patent Application Publication
(10) Pub. No.: US 2023/0343098 A1
(43) Pub. Date: Oct. 26, 2023

(54) SYSTEM AND METHOD FOR GENERATING AND DISPLAYING ATTENTION INDICATORS FOR A VIDEO CONFERENCE INTERFACE

(71) Applicant: Elisabeth Freeman, Boulder, CO (US)

(72) Inventor: Elisabeth Freeman, Boulder, CO (US)

(21) Appl. No.: 17/725,306

(22) Filed: Apr. 20, 2022

(51) Int. Cl. G06V 20/40; H04L 12/18

(52) U.S. Cl. CPC G06V 20/46; H04L 12/1831; G06V 20/41

(57) ABSTRACT

Described herein are systems, methods, and other techniques for generating and displaying attention indicators for video conference interfaces. A first video stream for a first user and a second video stream for a second user are received. The first video stream and the second video stream are analyzed to determine whether an attention event has been detected. In response to determining that an attention event has been detected for the first video stream, an attention indicator is generated for the first video steam. A video conference interface is generated that includes the first video stream, the second video stream, and the attention indicator that is superimposed with the first video stream. The video conference interface is displayed.

### BACKGROUND OF THE INVENTION

Distance learning (or virtual schooling) is often accomplished using videotelephony software (or video conference software) which provides for the transmission of audio and video signals between users that are physically located in different locations. For example, a teacher may operate a first computing device that captures audio and video data of the teacher that is transmitted to a second computing device that outputs the audio and video data. Similarly (and optionally), the second computing device may capture audio and video data of the student, which is transmitted to the first computing device so that the teacher may receive feedback, responses, or questions from the student.

Distance learning has both widened existing achievement gaps and created new ones, especially in cases where students are left unsupervised during virtual schooling. While many students may face struggles during virtual schooling, children left mostly or completely without physical monitoring are more likely to exhibit lessened engagement and, in turn, worsened quality of submitted work. Certain videotelephony software may employ activity-tracking techniques (e.g., software provided by ClassDojo, GoGuardian, etc.) that can be used to ensure students are on appropriate screens. However, such software requires close teacher attention and only monitors on-screen distractions.

### SUMMARY OF THE INVENTION

One general aspect includes a computer-implemented method. The computer-implemented method also includes receiving a first video stream for a first user and a second video stream for a second user. The computer-implemented method also includes analyzing the first video stream and the second video stream to determine whether an attention event has been detected for either the first video stream or the second video stream. The computer-implemented 30 method also includes in response to determining that an attention event has been detected for the first video stream, generating an attention indicator to be displayed superimposed with the first video steam. The computer-implemented method also includes generating a video conference interface that includes the first video stream, the second video stream, and the attention indicator that is superimposed with the first video stream. The computer-implemented method also includes displaying the video conference interface. Other embodiments of this aspect include corresponding computer systems, apparatus, and computer programs recorded on one or more computer storage devices, each configured to perform the actions of the methods.

Implementations may include one or more of the following features. The computer-implemented where the video conference interface further includes a first user identifier for the first user that is superimposed with the first video stream and a second user identifier for the second user super that is superimposed with the second video stream, and where the attention indicator is superimposed with the first user identifier. The computer-implemented further including: in response to determining that a second attention event has been detected for the second video stream, generating a second attention indicator to be displayed superimposed with the second video steam. The video conference interface further includes the second attention indicator that is superimposed with the second video stream. The video conference interface further includes a global attention indicator that is generated when either of the attention event or the second attention event has been detected. The attention indicator further includes audio information that is outputted while the video conference interface is displayed. The computer-implemented further including: receiving a first audio stream for the first user and a second audio stream for the second user; and while displaying the video conference interface, outputting the first audio stream or the second audio stream. Implementations of the described techniques may include hardware, a method or process, or computer software on a computer-accessible medium.

One general aspect includes a system. The system may include one or more processors. The system also includes a computer-readable medium including instructions that, when executed by the one or more processors, cause the one or more processors to perform operations The operations include receiving a first video stream for a first user and a second video stream for a second user. The operations also include analyzing the first video stream and the second video stream to determine whether an attention event has been detected for either the first video stream or the second video stream. The operations also include in response to determining that an attention event has been detected for the first video stream, generating an attention indicator to be displayed superimposed with the first video steam. The operations also include generating a video conference interface that includes the first video stream, the second video stream, and the attention indicator that is superimposed with the first video stream. The operations also include displaying the video conference interface. Other embodiments of this aspect include corresponding computer systems, apparatus, and computer programs recorded on one or more computer storage devices, each configured to perform the actions of the methods.

Implementations may include one or more of the following features. The system where the video conference interface further includes a first user identifier for the first user that is superimposed with the first video stream and a second user identifier for the second user super that is superimposed with the second video stream, and where the attention indicator is superimposed with the first user identifier. The system where the operations further include: in response to determining that a second attention event has been detected for the second video stream, generating a second attention indicator to be displayed superimposed with the second video steam. The video conference interface further includes the second attention indicator that is superimposed with the second video stream. The video conference interface further includes a global attention indicator that is generated when either of the attention event or the second attention event has been detected. The attention indicator further includes audio information that is outputted while the video conference interface is displayed. Implementations of the described techniques may include hardware, a method or process, or computer software on a computer-accessible medium.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and various ways in which it may be practiced.

FIG. 1 illustrates an example of a video conference interface that may be displayed on a computing device used by a teacher for a virtual classroom environment.

FIG. 2 illustrates an example of video conference interface in which multiple attention events are detected for multiple students.

FIG. 3 illustrates an example of video conference interface in which multiple attention events are detected for multiple students.

FIG. 4 illustrates a method for generating and displaying attention indicators.

FIG. 5 illustrates an example computer system comprising various hardware elements.

In the appended figures, similar components and/or features may have the same numerical reference label. Further, various components of the same type may be distinguished by following the reference label with a letter or by following the reference label with a dash followed by a second numerical reference label that distinguishes among the similar components and/or features. If only the first numerical reference label is used in the specification, the description is applicable to any one of the similar components and/or features having the same first numerical reference label, irrespective of the suffix.

### DETAILED DESCRIPTION OF THE INVENTION

Video conference technology allows teachers and students to interact in a “virtual classroom” environment. In some instances, a teacher may operate a first computing device (alternatively referred to as a “teacher computing device”) at a first location and may receive video data (or video streams) and audio data (or audio streams) from one or more computing devices (e.g., a second and a third computing device, alternatively referred to as “student computing devices”) being operated by students at one or more different locations (e.g., a second and a third location). The video and audio data received at the first computing device may be outputted within a video conference interface that is displayed on the first computing device. Video and audio data captured of the teacher at the first computing device may be transmitted and received at the second and third computing devices, and may also be outputted within video conference interfaces displayed on the second and third computing devices.

As another example, video and audio data captured of the teacher and students at the first, second, and third computing devices may be sent to a server computer, which may process the captured data and, based on the captured data, generate specific data needed by the computing devices in order to generate the video conference interfaces. This data may then be sent to the respective computing devices to be used to generate video conference interfaces for the teacher and students.

The above-described schemes allow a teacher to teach students in a virtual classroom environment. The teacher may provide instructions through the video conference interface, receive questions or feedback from the students, and provide responses to the student questions, etc. In some instances, virtual classroom environments may also be used to provide online examinations and other testing. In many cases, it may be important to monitor student behavior and possible ensure that students are paying attention to the teacher or testing materials and are avoiding inattentive behavior or suspicious activity that is indicative of cheating. For example, artificial intelligence (AI) or machine learning (ML) software may be used to perform eye-tracking or body tracking to ensure that students are not looking away from the display at the student computing devices. For teachers, it may be beneficial to be aware of students that are distracted or are exhibiting activity that is indicative of cheating.

Embodiments of the present invention relate to techniques for generating and outputting attention indicators for video conference interfaces. In some embodiments, video and/or audio data of students may be captured and received at a computing device or a server computer. The video and/or audio data may then be analyzed (e.g., using trained ML models) to determine whether the students are exhibiting behavior that demonstrates a lack of attention to the assigned task. When it is determined that a student is exhibiting such behavior, an attention event may be detected. In response to detecting the attention event, an attention indicator may be generated and displayed on the teacher's video conference interface in a manner that the attention indicator is superimposed with (e.g., associated with) the corresponding student's video feed, thereby flagging the student's thumbnail within the teacher's video conference interface.

The teacher may have a wide range of flexibility for adjusting the attention indicator. For example, using buttons or other interactable elements on the teacher's video conference interface, the teacher may change the color, size, or duration of a the displayed attention indicator. If the attention indicator includes an audio output, the teacher may increase or the decrease the volume of the audio output and reduce or extend its duration. The teacher may also adjust the sensitivity for detecting the attention event (e.g., amount of time needed that the student is exhibiting inattentive behavior before the attention event is detected). The types of behavior may also be modified. For example, the ML algorithm may look for inattentive behavior associated with the student's body or the student's hands and arms.

In some embodiments, the students may opt in to their video and/or audio data being analyzed for attention event detection. For example, in some embodiments, parental permission may be required before the student's video and audio data can be analyzed. In some embodiments, the students may be notified when an attention event has been detected for the student. This can allow the student to self-correct their behavior before the teacher has to intervene.

In the following description, various examples will be described. For purposes of explanation, specific configurations and details are set forth in order to provide a thorough understanding of the examples. However, it will also be apparent to one skilled in the art that the example may be practiced without the specific details. Furthermore, well-known features may be omitted or simplified in order not to obscure the embodiments being described.

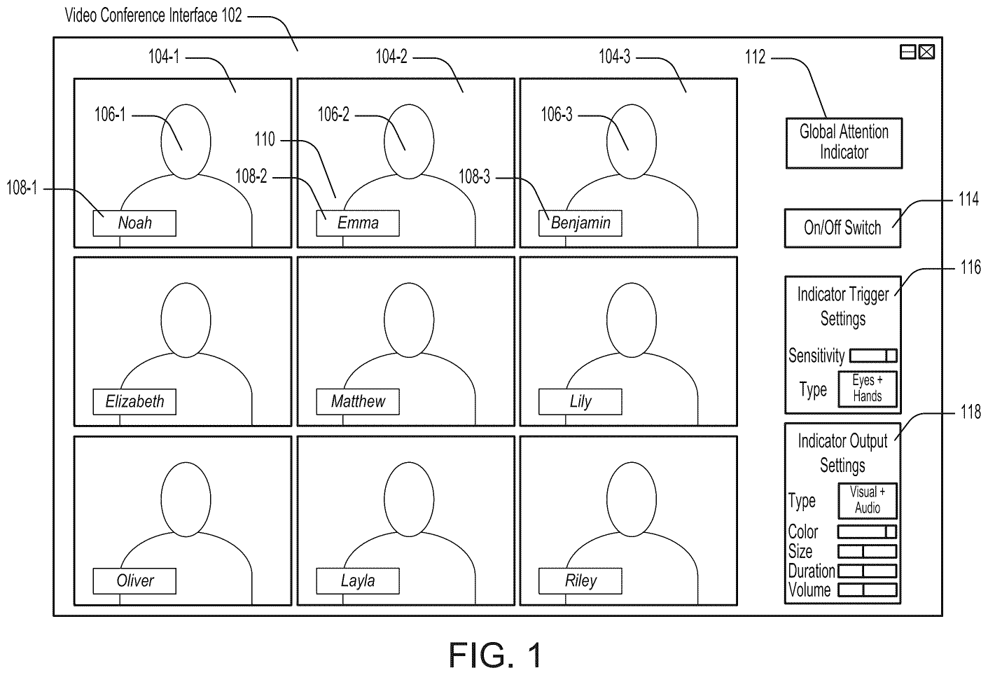

FIG. 1 illustrates an example of a video conference interface 102 that may, for example, be displayed on a computing device used by a teacher for a virtual classroom environment, in accordance with some embodiments of the present disclosure. Video conference interface 102 may include various graphical elements and audio outputs (e.g., audio outputs associated with the graphical elements). In the illustrated example, video conference interface 102 includes video streams 104 for various users 106. For example, a first video stream 104-1 of a first user 106-1, a second video stream 104-2 of a second user 106-2, and a third video stream 104-3 of a third user 106-3 may be displayed on video conference interface 102.

In some embodiments, video conference interface 102 may include user identifiers 108, such as name tags, that identify the names of users 106. For example, a first user identifier 108-1 of a first user 106-1 may be superimposed with first video stream 104-1, a second user identifier 108-2 of a second user 106-2 may be superimposed with second video stream 104-2, and a third user identifier 108-3 of a third user 106-3 may be superimposed with third video stream 104-3. While in the illustrated example user identifiers 108 are superimposed with video streams 104 at the bottom left of each video stream, user identifiers 108 may be positioned elsewhere relative to video streams 104. Furthermore, while the layout of video conference interface 102 is in a grid shape, different layouts may be utilized in various embodiments of the present invention (e.g., a single horizontal or vertical arrangement of video streams).

In some embodiments, video conference interface 102 may include a global attention indicator 112 that is generated (e.g., visually activated) when any attention event for any of users 106 has been detected. In some embodiments, video conference interface 102 may include an on-off switch 114 that disables or enables the functionality of the attention indicator system, allowing the teacher to activate or deactivate the system.

In some embodiments, video conference interface 102 may include a set of indicator trigger settings 116 that modify the manner in which attention events are detected. For example, indicator trigger settings 116 may include a sensitivity adjustment for allowing the teacher to set the amount of inattentive behavior that needs to occur before an attention event is detected. This may be an amount of time associated with the inattentive behavior (e.g., 2 seconds, 5 seconds), a magnitude of the inattentive behavior (e.g., student is looking 10 degrees away from the display, student is looking 60 degrees away from the display), and the like. As another example, indicator trigger settings 116 may include a type of inattentive behavior, such as inattentive behavior associated with the student's hands or inattentive behavior associated with the student's eyes.

In some embodiments, video conference interface 102 may include indicator output settings 118 that modify the manner in which attention indicators are outputted in video conference interface 102. For example, indicator output settings 118 may include a type of attention indicator, such as a visual attention indicator, an audio attention indicator, or a visual and audio attention indicator. As another example, indicator output settings may include a color adjustment for the attention indicator, a size adjustment for the attention indicator, a duration adjustment for the attention indicator, and/or a volume adjustment for the attention indicator.

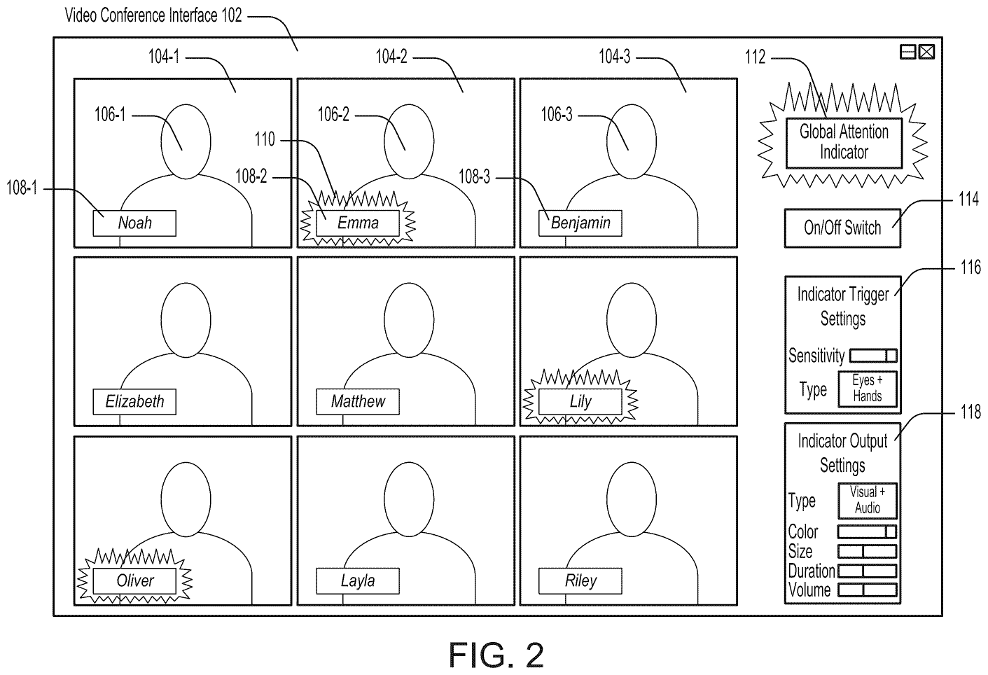

FIG. 2 illustrates an example of video conference interface 102 in which multiple attention events are detected for multiple students, in accordance with some embodiments of the present disclosure. In the illustrated example, video and/or audio data for the students “Emma”, “Lily”, and “Oliver” are analyzed using ML models to determine that they are exhibiting inattentive behavior, and accordingly attention events are detected for those students. In response, attention indicators 110 are generated and outputted on or near the corresponding video streams for those students. Furthermore, global attention indicator 112 is displayed and/or activated to show the teacher that at least one student is currently exhibiting inattentive behavior. The teacher may then examine the student thumbnails to identify the specific students that are exhibiting inattentive behavior.

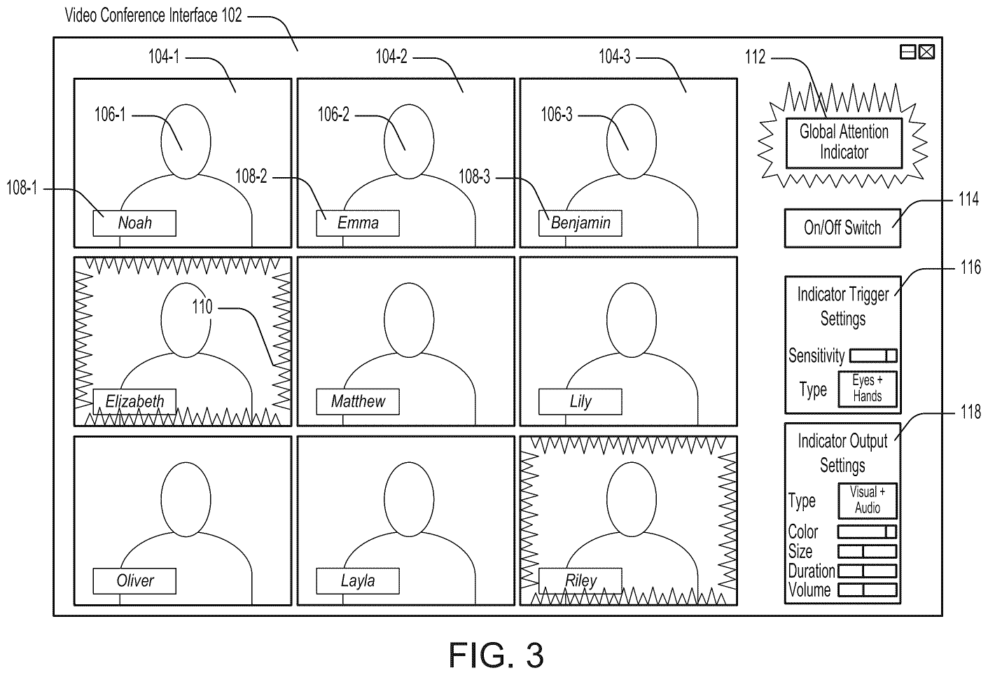

FIG. 3 illustrates an example of video conference interface 102 in which multiple attention events are detected for multiple students, in accordance with some embodiments of the present disclosure. In the illustrated example, video and/or audio data for the students “Elizabeth” and “Riley” are analyzed using ML models to determine that they are exhibiting inattentive behavior, and accordingly attention events are detected for those students. In response, attention indicators 110 are generated and outputted on or near the corresponding video streams for those students. In the illustrated example, indicator output settings 118 are adjusted such that attention indicators 110 are superimposed along the edges of video streams 104. Furthermore, global attention indicator 112 is displayed and/or activated to show the teacher that at least one student is currently exhibiting inattentive behavior.

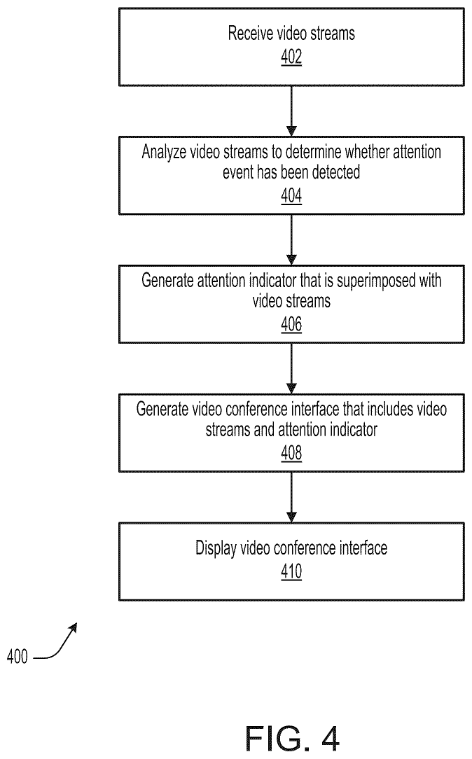

FIG. 4 illustrates a method 400, in accordance with some embodiments of the present disclosure. One or more steps of method 400 may be omitted during performance of method 400, and steps of method 400 may be performed in any order and/or in parallel. One or more steps of method 400 may be performed by one or more processors, such as those included in a teacher computing device, a student computing device, or a server computer. Method 400 may be implemented as a computer-readable medium or computer program product comprising instructions which, when the program is executed by one or more computers, cause the one or more computers to carry out the steps of method 400.

At step 402, a first video stream for a first user and a second video stream for a second user are received. The first video stream and the second video stream may be received at a teacher computing device or a server computer. In some embodiments a first audio stream for the first user and a second audio stream for the second user may also be received.

At step 404, the first video stream and the second video stream are analyzed to determine whether an attention event has been detected for either the first video stream or the second video stream. For example the first video stream may be analyzed to determine whether an attention event has been detected for the first video stream, and the second video stream may be analyzed to determine whether an attention event has been detected for the second video stream. In some embodiments, the first video stream and the second video stream are analyzed using a ML model trained to detect inattentive behavior. In some embodiments, an attention event may be detected for the first video stream. In some embodiments, an attention event may be detected for the second video stream. In some embodiments, an attention event may be detected for each of the first video stream and the second video stream. In some embodiments, the audio streams may be analyzed along with the video streams.

At step 406, in response to determining that an attention event has been detected for the first video stream, an attention indicator is generated to be displayed superimposed with the first video stream. The attention indicator may be generated by the teacher computing device or the server computer.

At step 408, a video conference interface is generated. The video conference interface may include the first video stream, the second of video stream, and the attention indicator that is superimposed with the first video stream. The video conference interface may be generated by the teacher computing device or the server computer.

At step 410, the video conference interface is displayed. The video conference interface may be displayed on a display of the teacher computing device. The teacher computing device may be a desktop computer, a laptop computer, a portable electronic device, or the like.

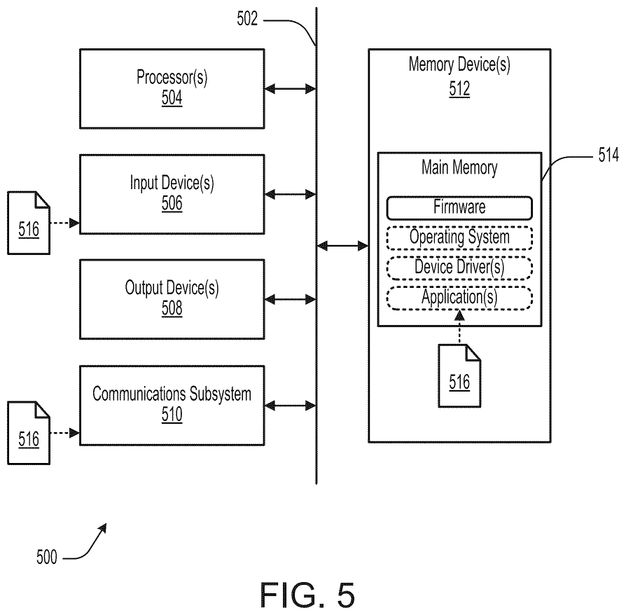

FIG. 5 illustrates an example computer system 500 comprising various hardware elements, in accordance with some embodiments of the present disclosure. Computer system 500 may be incorporated into or integrated with devices described herein and/or may be configured to perform some or all of the steps of the methods provided by various embodiments. For example, in various embodiments, computer system 500 may be incorporated into the teacher computing device, the student computing device, and/or the server computer and/or may be configured to perform method 400. It should be noted that FIG. 5 is meant only to provide a generalized illustration of various components, any or all of which may be utilized as appropriate. FIG. 5, therefore, broadly illustrates how individual system elements may be implemented in a relatively separated or relatively more integrated manner.

In the illustrated example, computer system 500 includes a communication medium 502, one or more processor(s) 504, one or more input device(s) 506, one or more output device(s) 508, a communications subsystem 510, and one or more memory device(s) 512. Computer system 500 may be implemented using various hardware implementations and embedded system technologies. For example, one or more elements of computer system 500 may be implemented as a field-programmable gate array (FPGA), such as those commercially available by XILINX®, INTEL®, or LATTICE SEMICONDUCTOR®, a system-on-a-chip (SoC), an application-specific integrated circuit (ASIC), an application-specific standard product (ASSP), a microcontroller, and/or a hybrid device, such as an SoC FPGA, among other possibilities.

The various hardware elements of computer system 500 may be communicatively coupled via communication medium 502. While communication medium 502 is illustrated as a single connection for purposes of clarity, it should be understood that communication medium 502 may include various numbers and types of communication media for transferring data between hardware elements. For example, communication medium 502 may include one or more wires (e.g., conductive traces, paths, or leads on a printed circuit board (PCB) or integrated circuit (IC), microstrips, striplines, coaxial cables), one or more optical waveguides (e.g., optical fibers, strip waveguides), and/or one or more wireless connections or links (e.g., infrared wireless communication, radio communication, microwave wireless communication), among other possibilities.

In some embodiments, communication medium 502 may include one or more buses connecting pins of the hardware elements of computer system 500. For example, communication medium 502 may include a bus that connects processor(s) 504 with main memory 514, referred to as a system bus, and a bus that connects main memory 514 with input device(s) 506 or output device(s) 508, referred to as an expansion bus. The system bus may itself consist of several buses, including an address bus, a data bus, and a control bus. The address bus may carry a memory address from processor(s) 504 to the address bus circuitry associated with main memory 514 in order for the data bus to access and carry the data contained at the memory address back to processor(s) 504. The control bus may carry commands from processor(s) 504 and return status signals from main memory 514. Each bus may include multiple wires for carrying multiple bits of information and each bus may support serial or parallel transmission of data.

Processor(s) 504 may include one or more central processing units (CPUs), graphics processing units (GPUs), neural network processors or accelerators, digital signal processors (DSPs), and/or other general-purpose or special-purpose processors capable of executing instructions. A CPU may take the form of a microprocessor, which may be fabricated on a single IC chip of metal-oxide-semiconductor field-effect transistor (MOSFET) construction. Processor(s) 504 may include one or more multi-core processors, in which each core may read and execute program instructions concurrently with the other cores, increasing speed for programs that support multithreading.

Input device(s) 506 may include one or more of various user input devices such as a mouse, a keyboard, a microphone, as well as various sensor input devices, such as an image capture device, a pressure sensor (e.g., barometer, tactile sensor), a temperature sensor (e.g., thermometer, thermocouple, thermistor), a movement sensor (e.g., accelerometer, gyroscope, tilt sensor), a light sensor (e.g., photodiode, photodetector, charge-coupled device), and/or the like. Input device(s) 506 may also include devices for reading and/or receiving removable storage devices or other removable media. Such removable media may include optical discs (e.g., Blu-ray discs, DVDs, CDs), memory cards (e.g., CompactFlash card, Secure Digital (SD) card, Memory Stick), floppy disks, Universal Serial Bus (USB) flash drives, external hard disk drives (HDDs) or solid-state drives (SSDs), and/or the like.

Output device(s) 508 may include one or more of various devices that convert information into human-readable form, such as without limitation a display device, a speaker, a printer, a haptic or tactile device, and/or the like. Output device(s) 508 may also include devices for writing to removable storage devices or other removable media, such as those described in reference to input device(s) 506. Output device(s) 508 may also include various actuators for causing physical movement of one or more components. Such actuators may be hydraulic, pneumatic, electric, and may be controlled using control signals generated by computer system 500.

Communications subsystem 510 may include hardware components for connecting computer system 500 to systems or devices that are located external to computer system 500, such as over a computer network. In various embodiments, communications subsystem 510 may include a wired communication device coupled to one or more input/output ports (e.g., a universal asynchronous receiver-transmitter (UART)), an optical communication device (e.g., an optical modem), an infrared communication device, a radio communication device (e.g., a wireless network interface controller, a BLUETOOTH® device, an IEEE 802.11 device, a Wi-Fi device, a Wi-Max device, a cellular device), among other possibilities.

Memory device(s) 512 may include the various data storage devices of computer system 500. For example, memory device(s) 512 may include various types of computer memory with various response times and capacities, from faster response times and lower capacity memory, such as processor registers and caches (e.g., L0, L1, L2), to medium response time and medium capacity memory, such as random-access memory (RAM), to lower response times and lower capacity memory, such as solid-state drives and hard drive disks. While processor(s) 504 and memory device(s) 512 are illustrated as being separate elements, it should be understood that processor(s) 504 may include varying levels of on-processor memory, such as processor registers and caches that may be utilized by a single processor or shared between multiple processors.

Memory device(s) 512 may include main memory 514, which may be directly accessible by processor(s) 504 via the memory bus of communication medium 502. For example, processor(s) 504 may continuously read and execute instructions stored in main memory 514. As such, various software elements may be loaded into main memory 514 to be read and executed by processor(s) 504 as illustrated in FIG. 5. Typically, main memory 514 is volatile memory, which loses all data when power is turned off and accordingly needs power to preserve stored data. Main memory 514 may further include a small portion of non-volatile memory containing software (e.g., firmware, such as BIOS) that is used for reading other software stored in memory device(s) 512 into main memory 514. In some embodiments, the volatile memory of main memory 514 is implemented as RAM, such as dynamic random-access memory (DRAM), and the non-volatile memory of main memory 514 is implemented as read-only memory (ROM), such as flash memory, erasable programmable read-only memory (EPROM), or electrically erasable programmable read-only memory (EEPROM).

Computer system 500 may include software elements, shown as being currently located within main memory 514, which may include an operating system, device driver(s), firmware, compilers, and/or other code, such as one or more application programs, which may include computer programs provided by various embodiments of the present disclosure. Merely by way of example, one or more steps described with respect to any methods discussed above, may be implemented as instructions 516, which are executable by computer system 500. In one example, such instructions 516 may be received by computer system 500 using communications subsystem 510 (e.g., via a wireless or wired signal that carries instructions 516), carried by communication medium 502 to memory device(s) 512, stored within memory device(s) 512, read into main memory 514, and executed by processor(s) 504 to perform one or more steps of the described methods. In another example, instructions 516 may be received by computer system 500 using input device(s) 506 (e.g., via a reader for removable media), carried by communication medium 502 to memory device(s) 512, stored within memory device(s) 512, read into main memory 514, and executed by processor(s) 504 to perform one or more steps of the described methods.

In some embodiments of the present disclosure, instructions 516 are stored on a computer-readable storage medium (or simply computer-readable medium). Such a computer-readable medium may be non-transitory and may therefore be referred to as a non-transitory computer-readable medium. In some cases, the non-transitory computer-readable medium may be incorporated within computer system 500. For example, the non-transitory computer-readable medium may be one of memory device(s) 512 (as shown in FIG. 5). In some cases, the non-transitory computer-readable medium may be separate from computer system 500. In one example, the non-transitory computer-readable medium may be a removable medium provided to input device(s) 506 (as shown in FIG. 5), such as those described in reference to input device(s) 506, with instructions 516 being read into computer system 500 by input device(s) 506. In another example, the non-transitory computer-readable medium may be a component of a remote electronic device, such as a mobile phone, that may wirelessly transmit a data signal that carries instructions 516 to computer system 500 and that is received by communications subsystem 510 (as shown in FIG. 5).

Instructions 516 may take any suitable form to be read and/or executed by computer system 500. For example, instructions 516 may be source code (written in a human-readable programming language such as Java, C, C++, C #, Python), object code, assembly language, machine code, microcode, executable code, and/or the like. In one example, instructions 516 are provided to computer system 500 in the form of source code, and a compiler is used to translate instructions 516 from source code to machine code, which may then be read into main memory 514 for execution by processor(s) 504. As another example, instructions 516 are provided to computer system 500 in the form of an executable file with machine code that may immediately be read into main memory 514 for execution by processor(s) 504. In various examples, instructions 516 may be provided to computer system 500 in encrypted or unencrypted form, compressed or uncompressed form, as an installation package or an initialization for a broader software deployment, among other possibilities.

In one aspect of the present disclosure, a system (e.g., computer system 500) is provided to perform methods in accordance with various embodiments of the present disclosure. For example, some embodiments may include a system comprising one or more processors (e.g., processor(s) 504) that are communicatively coupled to a non-transitory computer-readable medium (e.g., memory device(s) 512 or main memory 514). The non-transitory computer-readable medium may have instructions (e.g., instructions 516) stored therein that, when executed by the one or more processors, cause the one or more processors to perform the methods described in the various embodiments.

In another aspect of the present disclosure, a computer-program product that includes instructions (e.g., instructions 516) is provided to perform methods in accordance with various embodiments of the present disclosure. The computer-program product may be tangibly embodied in a non-transitory computer-readable medium (e.g., memory device(s) 512 or main memory 514). The instructions may be configured to cause one or more processors (e.g., processor(s) 504) to perform the methods described in the various embodiments.

In another aspect of the present disclosure, a non-transitory computer-readable medium (e.g., memory device(s) 512 or main memory 514) is provided. The non-transitory computer-readable medium may have instructions (e.g., instructions 516) stored therein that, when executed by one or more processors (e.g., processor(s) 504), cause the one or more processors to perform the methods described in the various embodiments.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes reference to one or more of such users, and reference to “a processor” includes reference to one or more processors and equivalents thereof known to those skilled in the art, and so forth.

Also, the words “comprise,” “comprising,” “contains,” “containing,” “include,” “including,” and “includes,” when used in this specification and in the following claims, are intended to specify the presence of stated features, integers, components, or steps, but they do not preclude the presence or addition of one or more other features, integers, components, steps, acts, or groups.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A computer-implemented method comprising:
receiving a first video stream for a first user and a second video stream for a second user;
analyzing the first video stream and the second video stream to determine whether an attention event has been detected for either the first video stream or the second video stream;
in response to determining that an attention event has been detected for the first video stream, generating an attention indicator to be displayed superimposed with the first video steam;
generating a video conference interface that includes the first video stream, the second video stream, and the attention indicator that is superimposed with the first video stream; and
displaying the video conference interface.

2. The computer-implemented method of claim 1, wherein the video conference interface further includes a first user identifier for the first user that is superimposed with the first video stream and a second user identifier for the second user super that is superimposed with the second video stream, and wherein the attention indicator is superimposed with the first user identifier.

3. The computer-implemented method of claim 1, further comprising:
in response to determining that a second attention event has been detected for the second video stream, generating a second attention indicator to be displayed superimposed with the second video steam.

4. The computer-implemented method of claim 3, wherein the video conference interface further includes the second attention indicator that is superimposed with the second video stream.

5. The computer-implemented method of claim 3, wherein the video conference interface further includes a global attention indicator that is generated when either of the attention event or the second attention event has been detected.

6. The computer-implemented method of claim 1, wherein the attention indicator further includes audio information that is outputted while the video conference interface is displayed.

7. The computer-implemented method of claim 1, further comprising:
receiving a first audio stream for the first user and a second audio stream for the second user; and
while displaying the video conference interface, outputting the first audio stream or the second audio stream.

8. A non-transitory computer-readable medium comprising instructions that, when executed by one or more processors, cause the one or more processors to perform operations comprising:
receiving a first video stream for a first user and a second video stream for a second user;
analyzing the first video stream and the second video stream to determine whether an attention event has been detected for either the first video stream or the second video stream;
in response to determining that an attention event has been detected for the first video stream, generating an attention indicator to be displayed superimposed with the first video steam;
generating a video conference interface that includes the first video stream, the second video stream, and the attention indicator that is superimposed with the first video stream; and
displaying the video conference interface.

9. The non-transitory computer-readable medium of claim 8, wherein the video conference interface further includes a first user identifier for the first user that is superimposed with the first video stream and a second user identifier for the second user super that is superimposed with the second video stream, and wherein the attention indicator is superimposed with the first user identifier.

10. The non-transitory computer-readable medium of claim 8, further comprising:
in response to determining that a second attention event has been detected for the second video stream, generating a second attention indicator to be displayed superimposed with the second video steam.

11. The non-transitory computer-readable medium of claim 10, wherein the video conference interface further includes the second attention indicator that is superimposed with the second video stream.

12. The non-transitory computer-readable medium of claim 10, wherein the video conference interface further includes a global attention indicator that is generated when either of the attention event or the second attention event has been detected.

13. The non-transitory computer-readable medium of claim 8, wherein the attention indicator further includes audio information that is outputted while the video conference interface is displayed.

14. The non-transitory computer-readable medium of claim 8, further comprising:
receiving a first audio stream for the first user and a second audio stream for the second user; and
while displaying the video conference interface, outputting the first audio stream or the second audio stream.

15. A system comprising,
one or more processors; and
a computer-readable medium comprising instructions that, when executed by the one or more processors, cause the one or more processors to perform operations comprising:
receiving a first video stream for a first user and a second video stream for a second user;
analyzing the first video stream and the second video stream to determine whether an attention event has been detected for either the first video stream or the second video stream;
in response to determining that an attention event has been detected for the first video stream, generating an attention indicator to be displayed superimposed with the first video steam;
generating a video conference interface that includes the first video stream, the second video stream, and the attention indicator that is superimposed with the first video stream; and
displaying the video conference interface.

16. The system of claim 15, wherein the video conference interface further includes a first user identifier for the first user that is superimposed with the first video stream and a second user identifier for the second user super that is superimposed with the second video stream, and wherein the attention indicator is superimposed with the first user identifier.

17. The system of claim 15, further comprising:
in response to determining that a second attention event has been detected for the second video stream, generating a second attention indicator to be displayed superimposed with the second video steam.

18. The system of claim 17, wherein the video conference interface further includes the second attention indicator that is superimposed with the second video stream.

19. The system of claim 17, wherein the video conference interface further includes a global attention indicator that is generated when either of the attention event or the second attention event has been detected.

20. The system of claim 15, wherein the attention indicator further includes audio information that is outputted while the video conference interface is displayed.
